(19) United States
(12) Patent Application Publication
(10) Pub. No.: US 2026/0307613 A1
(43) Pub. Date: Oct. 8, 2026

(54) AIR-BAG

(71) Applicants: SEIREN CO., LTD., Fukui-shi (JP); HONDA MOTOR CO., LTD., Tokyo (JP)

(72) Inventors: Tsuyoshi Houraiya, Fukui-shi (JP); Hisaki Sugaya, Tokyo (JP); Tadashi Inazu, Wako-shi (JP)

(73) Assignees: SEIREN CO., LTD., Fukui-shi (JP); HONDA MOTOR CO., LTD., Tokyo (JP)

(21) Appl. No.: 19/630,845

(22) Filed: Mar. 27, 2026

(30) Foreign Application Priority Data
Apr. 3, 2025 (JP) 2025-061837

(51) Int. Cl. B60R 21/233; B60R 21/235

(52) U.S. Cl. CPC B60R 21/233; B60R 21/235; B60R 2021/23324; B60R 2021/23509; B60R 2021/23538

(57) ABSTRACT

An air-bag include a main chamber that is inflated by gas supplied from an inflator and a sub-chamber that is inflated by being supplied with the gas from the main chamber through a vent hole. The main chamber is made of a low elongation base fabric, and at least a part of the sub-chamber is made of a high elongation base fabric having larger breaking elongation than the low elongation base fabric.

### CROSS-REFERENCE TO RELATED APPLICATIONS

This application claims the benefit of and priority to Japanese Patent Application No. 2025-061837, filed on Apr. 3, 2025, and the content thereof is incorporated herein by reference in its entirety.

### BACKGROUND OF THE INVENTION

### 1. Field of the Invention

The present invention relates to an air-bag including a main chamber and a sub-chamber.

### 2. Description of Related Art

For example, as described in JP2018-127156A, an air-bag including a main chamber and a sub-chamber is known. The main chamber is inflated by being directly supplied with gas injected from an inflator. The sub-chamber is inflated by being supplied with the gas from the main chamber through a vent hole opening between the main chamber and the sub-chamber. The sub-chamber is inflated to a location that cannot be protected only by the main chamber.

The main chamber and the sub-chamber are made of the same base fabric. A general base fabric is made by providing a silicon resin layer to a woven fabric that is made of nylon yarns or polyester yarns. The resin layer has functions of reducing a ventilation amount of the base fabric, maintaining the shape of the air-bag when inflated, and suppressing the occurrence of frays of the base fabric.

### SUMMARY OF THE INVENTION

Incidentally, the inflated air-bag has a high internal pressure, and when a person hits the air-bag, the person receives an impact.

Therefore, an object of the present invention is to provide an air-bag that can sufficiently reduce an impact to a person.

The invention includes the following embodiments.

[1] An air-bag including:

a main chamber that is inflated by gas supplied from an inflator; and

a sub-chamber that is inflated by being supplied with the gas through a vent hole formed in the main chamber,

wherein the main chamber is made of a low elongation base fabric, and at least a part of the sub-chamber is made of a high elongation base fabric having larger breaking elongation than the low elongation base fabric.

[2] The air-bag according to [1], wherein the breaking elongation of the high elongation base fabric is 400% or more.

[3] The air-bag according to [1] or [2], wherein

the main chamber includes, as surfaces during inflation, a front surface located at a position facing the inflator and side surfaces located on both left and right sides of the front surface, and

the vent hole is provided at least one of the side surfaces.

[4] The air-bag according to any one of [1] to [3], wherein a coupling portion of a base fabric forming the sub-chamber to the main chamber is formed of one curved line as a whole.

[5] The air-bag according to any one of [1] to [4], wherein

the sub-chamber includes

a first chamber forming base fabric coupled to the main chamber so as to cover the vent hole and a peripheral portion of the vent hole, and

a second chamber forming base fabric coupled to the first chamber forming base fabric so as to cover a ventilation hole formed in the first chamber forming base fabric and a peripheral portion of the ventilation hole,

an interior of the sub-chamber is divided into a first chamber surrounded by the main chamber and the first chamber forming base fabric, and a second chamber surrounded by the first chamber forming base fabric and the second chamber forming base fabric, and

the first chamber forming base fabric is made of the low elongation base fabric and the second chamber forming base fabric is made of the high elongation base fabric.

[6] The air-bag according to any one of [1] to [4], wherein

the sub-chamber includes

a first base fabric portion having an opening that is coupled to the main chamber, and

a second base fabric portion placed on a portion including the opening of the first base fabric portion from an inner side of the sub-chamber,

the first base fabric portion is made of the low elongation base fabric,

the second base fabric portion is made of the high elongation base fabric,

the second base fabric portion is sewn on the first base fabric portion so as to surround the opening at a sewing position set on an outer side of the opening by a predetermined distance from an opening end of the opening, and

a slit is formed in the first base fabric portion from the opening end toward the sewing position.

[7] The air-bag according to any one of [1] to [4], wherein

the main chamber is formed with a sewing portion between the low elongation base fabric and the low elongation base fabric,

an entirety of the sub-chamber is made of the high elongation base fabric, and

on a straight line orthogonal to an extension line of the sewing portion, a distance from a coupling portion of the sub-chamber to the main chamber to the sewing portion is 15% or more of a length of the sub-chamber in a non-elongated state.

[8] The air-bag according to any one of [1] to [7], wherein an entirety of the main chamber is made of the low elongation base fabric.

The air-bag according to each of the above-described embodiments can sufficiently reduce an impact to a person because at least a part of the sub-chamber is made of the high elongation base fabric.

### BRIEF DESCRIPTION OF THE DRAWINGS

FIG. 1 is a perspective view of an air-bag according to a first embodiment that is inflated;

FIG. 2 is a cross-sectional view of a sub-chamber according to the first embodiment that is inflated;

FIG. 3 is a cross-sectional view of a sub-chamber according to a second embodiment that is inflated halfway;

FIG. 4 is a diagram of the sub-chamber according to the second embodiment in FIG. 3 as viewed from above;

FIG. 5 is a cross-sectional view of a sub-chamber according to a third embodiment that is inflated; and

FIG. 6 is a diagram of the sub-chamber according to the third embodiment in FIG. 5 as viewed from above.

### DESCRIPTION OF EMBODIMENTS

Embodiments will be described with reference to the accompanying drawings. The embodiments described below are merely examples, and changes appropriately made without departing from the gist of the present invention are also included in the scope of the present invention.

In the following description, front and back are expressions on the assumption that an inflation direction of an air-bag 10 is defined as front.

### 1. First Embodiment

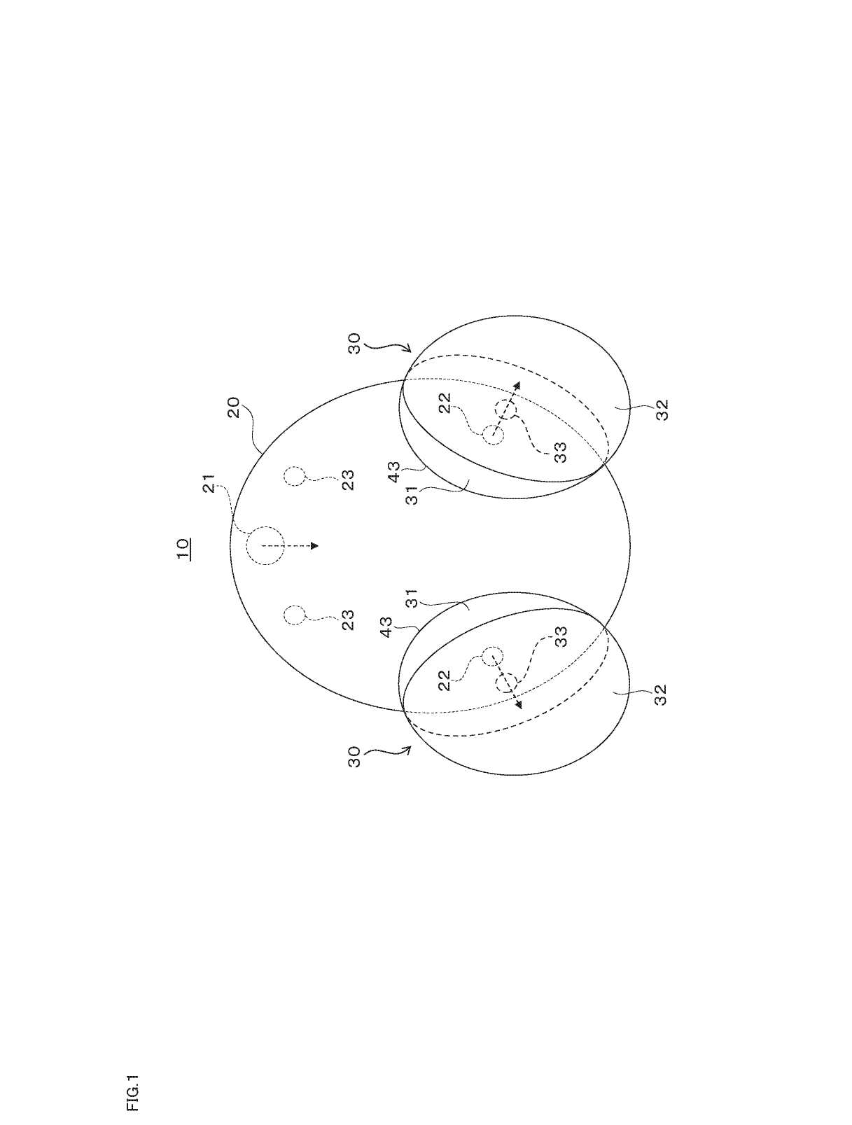

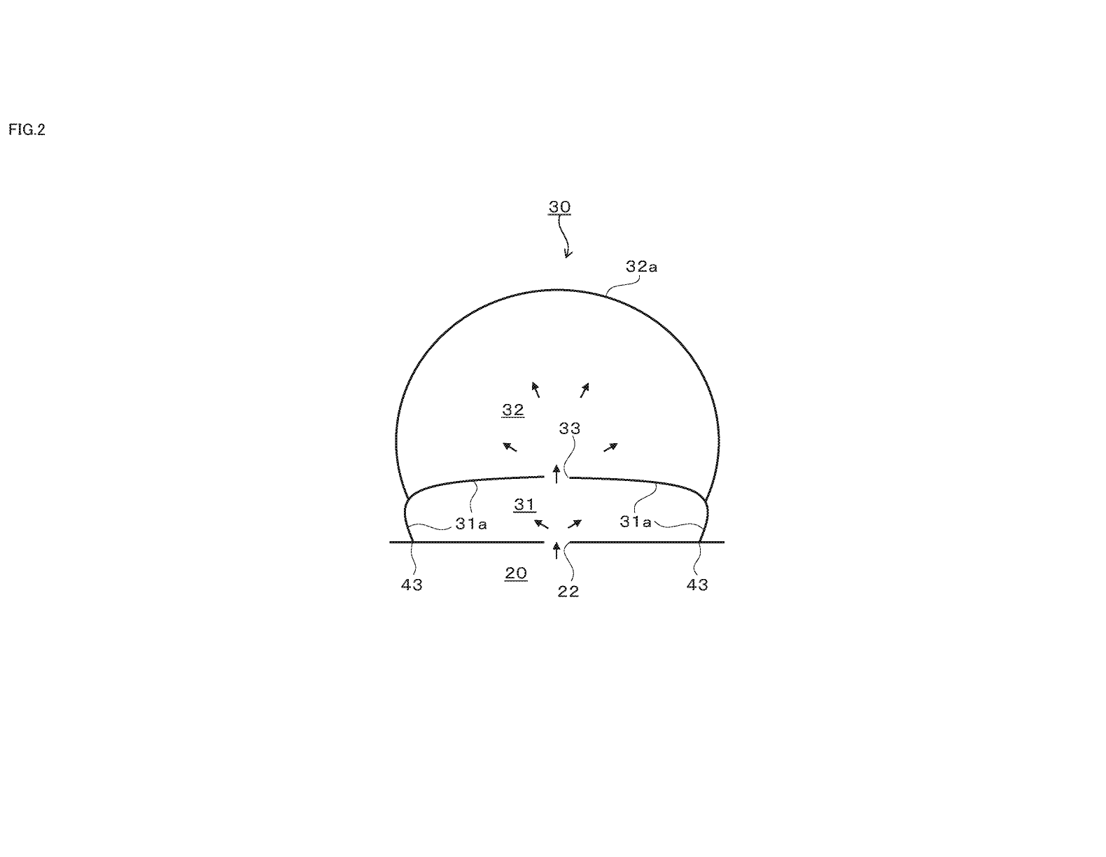

FIGS. 1 and 2 each illustrate a state in which the air-bag 10 according to the first embodiment is inflated. The air-bag 10 is a part of an air-bag device. The air-bag device includes a sensor that detects that a vehicle has received an impact, an inflator that injects gas based on a signal from the sensor, and the air-bag 10 that is inflated by the gas supplied from the inflator. As illustrated in FIG. 1, the air-bag 10 includes one main chamber 20 and two sub-chambers 30.

The main chamber 20 is a bag-shaped part whose interior constitutes one space. The main chamber 20 is provided with a supply port 21 of the gas from the inflator, two ventilation vent holes 22 for passing the gas from the main chamber 20 to each of the sub-chambers 30, and an exhaust vent hole 23 for discharging the gas from the air-bag 10 to the outside.

The ventilation vent hole 22 is a hole opening in a base fabric that forms the main chamber 20, and the area thereof is sufficiently smaller than the area of a portion of the main chamber 20 covered by the sub-chamber 30 (i.e., a boundary surface between the main chamber 20 and the sub-chamber 30). A structure for controlling the flow direction of the gas, the flow rate of the gas, or the like may be added to the ventilation vent hole 22.

The main chamber 20 has, as surfaces during inflation, at least a front surface which is a surface located at a position facing the inflator, and side surfaces which are surfaces located on both left and right sides of the front surface. In the main chamber 20 with such a configuration, the ventilation vent holes 22 are preferably formed in the respective two side surfaces. The range of the side surface is a range in which an extension line of a perpendicular line to a surface of the main chamber 20 is closest to a left and right direction among six directions of an up and down direction, a left and right direction, and a front and back direction.

On the other hand, the exhaust vent hole 23 is provided to a surface of the main chamber 20 on the back side (on the vehicle exterior side). The exhaust vent hole 23 is a hole having the same size as the ventilation vent hole 22. A structure for controlling the flow rate of the gas or the like may be added to the exhaust vent hole 23.

Each of the sub-chambers 30 is provided so as to cover the ventilation vent hole 22 in the main chamber 20 and a peripheral portion thereof from the outer side of the main chamber 20. The sub-chamber 30 is sewn and coupled to the main chamber 20. A sewing portion between the sub-chamber 30 and the main chamber 20 (i.e., a coupling portion 43 between base fabrics of the sub-chamber 30 and the main chamber 20) is formed of one curved line as a whole, and draws a circle or an ellipse, for example.

The two sub-chambers 30 are disposed symmetrically with respect to the main chamber 20, and have symmetrical structures. The interior of the sub-chamber 30 is divided into a first chamber 31 on the main chamber 20 side and a second chamber 32 farther from the main chamber 20.

The first chamber 31 is formed such that a first chamber forming base fabric 31a (see FIG. 2), which is formed by sewing a plurality of base fabrics to form a three-dimensional shape, covers the ventilation vent hole 22 in the main chamber 20 and a peripheral portion thereof from the outer side of the main chamber 20.

A ventilation hole 33 opens in a surface of the first chamber forming base fabric 31a facing the main chamber 20. The ventilation hole 33 is a hole having the same size as the ventilation vent hole 22. A structure for controlling any of the flow direction of the gas, the flow rate of the gas, or the like may be added to the ventilation hole 33.

The second chamber 32 is formed such that a second chamber forming base fabric 32a (see FIG. 2), which is made of one or a plurality of base fabrics, covers the ventilation hole 33 in the first chamber forming base fabric 31a and a peripheral portion thereof from a side opposite to the main chamber 20. The second chamber forming base fabric 32a has no hole. The second chamber forming base fabric 32a is sewn and coupled to the first chamber forming base fabric 31a.

With such a configuration, the interior of the sub-chamber 30 is divided into the first chamber 31 surrounded by the main chamber 20 and the first chamber forming base fabric 31a, and the second chamber 32 surrounded by the first chamber forming base fabric 31a and the second chamber forming base fabric 32a. A portion around the ventilation hole 33 of the first chamber forming base fabric 31a is a base fabric that partitions between the first chamber 31 and the second chamber 32.

In the air-bag 10 having such a configuration, the main chamber 20 is inflated by the gas supplied from the inflator. In addition, the first chamber 31 of the sub-chamber 30 is inflated by the gas supplied from the main chamber 20 through the ventilation vent hole 22. Further, the second chamber 32 of the sub-chamber 30 is inflated by the gas supplied from the first chamber 31 through the ventilation hole 33. The flow of the gas is indicated by arrows in FIG. 2.

The entirety of the main chamber 20 and the first chamber forming base fabric 31a are made of a low elongation base fabric. The low elongation base fabric preferably has breaking elongation of 10% or more and 50% or less. The low elongation base fabric has a base fabric main body which is a woven fabric, a knitted fabric, or an unwoven fabric made of non-stretchable yarns such as nylon yarns or polyester yarns, for example. Among them, the woven fabric is desirable as the base fabric main body in terms of strength and the like. As the woven fabric, a plain woven fabric is desirable from the viewpoint that properties such as strength are uniform in the vertical and horizontal directions, but any woven fabric such as a twill woven fabric, a satin woven fabric, or the like may be used.

The low elongation base fabric may be a coated fabric in which at least one side of the base fabric main body is coated with resin, or may be a non-coated fabric in which the base fabric main body is not coated with resin. Examples of the resin used for coating include silicon, acrylic, polyurethane, polyolefin, phenol, and polyester.

The second chamber forming base fabric 32a is made of a high elongation base fabric having breaking elongation of 400% or more. When needed, the upper and lower limits of the breaking elongation of the second chamber forming base fabric 32a are preferably set to be 400% or more and 800% or less, and more preferably set to be 400% or more and 600% or less. The high elongation base fabric has a base fabric main body which is a knitted fabric including elastic yarns such as polyurethane yarns, for example. As the knitted fabric, a circular knitted fabric, a weft knitted fabric, or a warp knitted fabric is used. Among them, the circular knitted fabric or the weft knitted fabric in which elastic yarns and non-elastic yarns are plating-knitted is desirable as the base fabric main body. As the structure of the circular knitted fabric or the weft knitted fabric, an interlock structure is preferable, but other structures such as a mock-rody structure may be used.

The high elongation base fabric may be a coated fabric in which at least one side of the base fabric main body is coated with resin, or may be a non-coated fabric in which the base fabric main body is not coated with resin. The resin used for coating is preferably resin having high stretchability and having larger breaking elongation than the base fabric main body in a single resin state. Specific examples of the resin include silicon resin having breaking elongation of 1400% or more and 1600% or less.

Note that the breaking elongation is breaking elongation measured based on Method A described in JIS L 1096, paragraph 8.14.1. In a case where a coated fabric is used as the low elongation base fabric or the high elongation base fabric, the breaking elongation means breaking elongation in a state including a resin layer (i.e., after the coating).

The air-bag 10 with such a configuration is provided, for example, in front of a front passenger seat of a vehicle in order to protect a passenger on the front passenger seat. When the vehicle receives an impact, the sensor of the air-bag device detects the impact and gas is injected from the inflator. Due to the gas, the main chamber 20 is first inflated toward the passenger on the front passenger seat, and then the first chamber 31 and the second chamber 32 of the sub-chamber 30 are inflated toward side spaces with respect to the passenger on the front passenger seat.

Here, since the main chamber 20 is formed of the low elongation base fabric that is less stretchable, the internal pressure of the main chamber 20 is rapidly increased, and the gas is quickly supplied from the main chamber 20 to the first chamber 31 of the sub-chamber 30. Since the first chamber 31 is also formed of the low elongation base fabric, the gas is quickly supplied from the first chamber 31 to the second chamber 32.

In a case where the passenger on the front passenger seat falls sideways when the air-bag 10 is inflated, for example, the head of the passenger hits an inflated portion of the second chamber 32 of the sub-chamber 30. Then, the high elongation base fabric forming the second chamber 32 is elongated, and thus a rapid increase in the internal pressure of the air-bag 10 is prevented. In addition, the high elongation base fabric is elongated and hits the passenger like a cushion. Accordingly, the impact to the passenger can be sufficiently reduced.

The effects of the first embodiment will be described. In the air-bag 10 according to the first embodiment, a part of the sub-chamber 30 is made of the high elongation base fabric having breaking elongation of 400% or more, and thus the impact to the passenger can be sufficiently reduced as described above. On the other hand, the main chamber 20 is made of the low elongation base fabric having breaking elongation of 10% or more and 50% or less, and thus the entirety of the air-bag 10 can be rapidly inflated. In addition, the high elongation base fabric is less durable than the low elongation base fabric, whereas instead of the high elongation base fabric, the low elongation base fabric is used for the main chamber 20 to which the gas is directly injected from the inflator and a high load is applied, and thus the main chamber 20 is less likely to burst.

Further, a part of the sub-chamber 30 is made of the high elongation base fabric, the sub-chamber 30 is likely to be inflated in a three-dimensional shape when the gas is supplied into the sub-chamber 30. Thus, the number of the high elongation base fabrics required to form the sub-chamber 30 in a three-dimensional shape can be reduced, and the productivity of the air-bag 10 is high.

In the related art, an air-bag including a main chamber and a sub-chamber is made of a non-stretchable base fabric as a whole and, in order to inflate such an air-bag rapidly and three-dimensionally, it is necessary to add base fabrics, add sewing portions, or devise the shape, making the structure of the air-bag complicated. In contrast, in the air-bag 10 according to the first embodiment, since the main chamber 20 is made of the low elongation base fabric and a part of the sub-chamber 30 is made of the high elongation base fabric, the air-bag 10 can be inflated rapidly and three-dimensionally, making the structure of the air-bag 10 simplified.

The shape of the sub-chamber 30 when inflated can be easily controlled when the breaking elongation of the high elongation base fabric is 800% or less, and the shape can be more easily controlled when the breaking elongation is 600% or less.

Since each of the ventilation vent holes 22 is formed in the side surface of the main chamber 20, a large load is instantaneously applied to the first chamber forming base fabric 31a and the second chamber forming base fabric 32a that form the sub-chamber 30, the second chamber forming base fabric 32a made of the high elongation base fabric is more largely elongated and the sub-chamber 30 is more largely inflated.

In addition, since the coupling portion 43 of the sub-chamber 30 to the main chamber 20 is formed of one curved line as a whole and draws, for example, a circle or an ellipse, a substantially uniform load is applied to the entirety of the coupling portion 43 when the sub-chamber 30 is inflated, and it is possible to prevent a high load from being applied to only a part of the coupling portion 43. Accordingly, the coupling portion 43 is less likely to be torn.

The sub-chamber 30 includes the first chamber 31 on the main chamber 20 side and the second chamber 32 farther from the main chamber 20. The second chamber 32, which is located farther from the main chamber 20 and is likely to hit the passenger, is formed of the high elongation base fabric, and thus the impact to the passenger can be sufficiently reduced. On the other hand, the first chamber 31 on the main chamber 20 side is formed of the low elongation base fabric, and thus the main chamber 20 can be prevented from being affected by the second chamber 32 being largely inflated.

Various changes can be made to the first embodiment.

For example, the number of the sub-chambers provided to the main chamber may be one or three or more. The position at which the sub-chamber is coupled to the main chamber may be changed depending on a position at which the sub-chamber is desired to be expanded.

When the air-bag according to the invention is used for a passenger vehicle, the air-bag can be used as a driver's seat air-bag, a side air-bag, a side curtain air-bag, and the like, in addition to a passenger seat air-bag. The air-bag according to the invention can be used for a commercial vehicle, a bus, a motorcycle, an airplane, a train, play equipment, or the like, in addition to a passenger vehicle.

The portions described as being sewn and coupled may be coupled by coupling means other than sewing, for example, bonding using adhesive.

As the high elongation base fabric, a base fabric having breaking elongation of less than 400% may be used. However, the high elongation base fabric has larger breaking elongation than the low elongation base fabric.

### 2. Second Embodiment

An air-bag according to the second embodiment differs from the first embodiment only in the configuration of the sub-chamber.

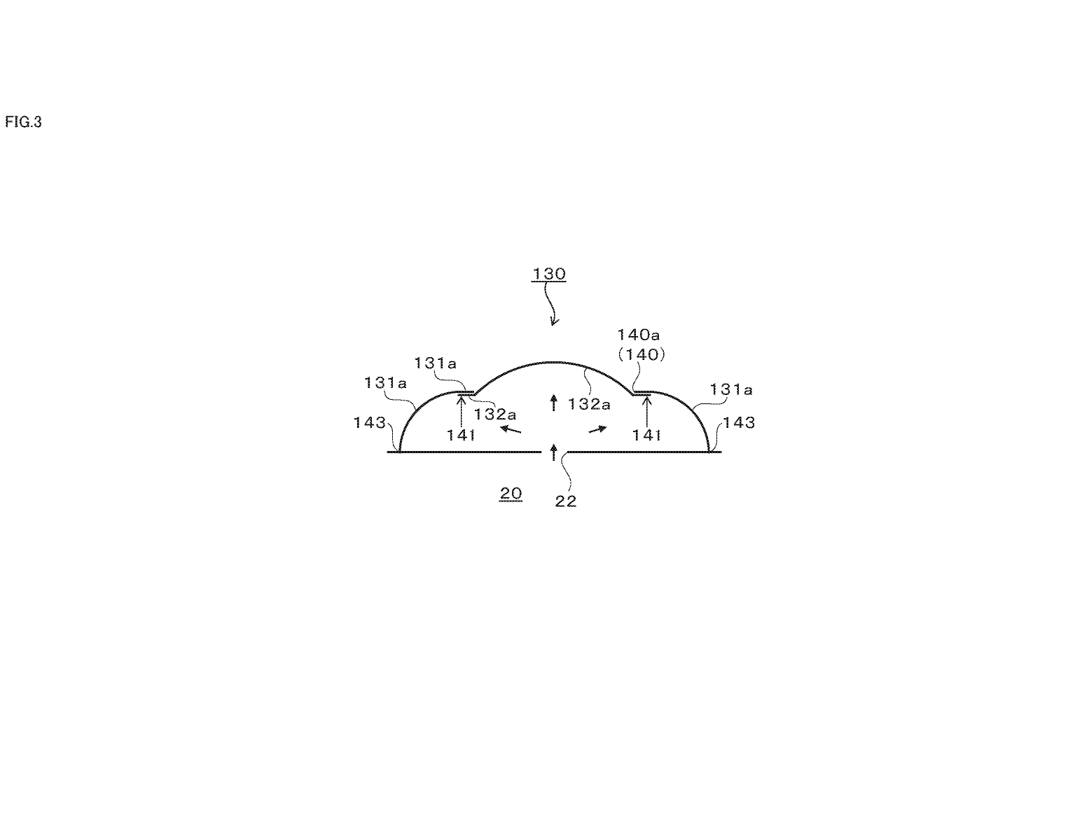

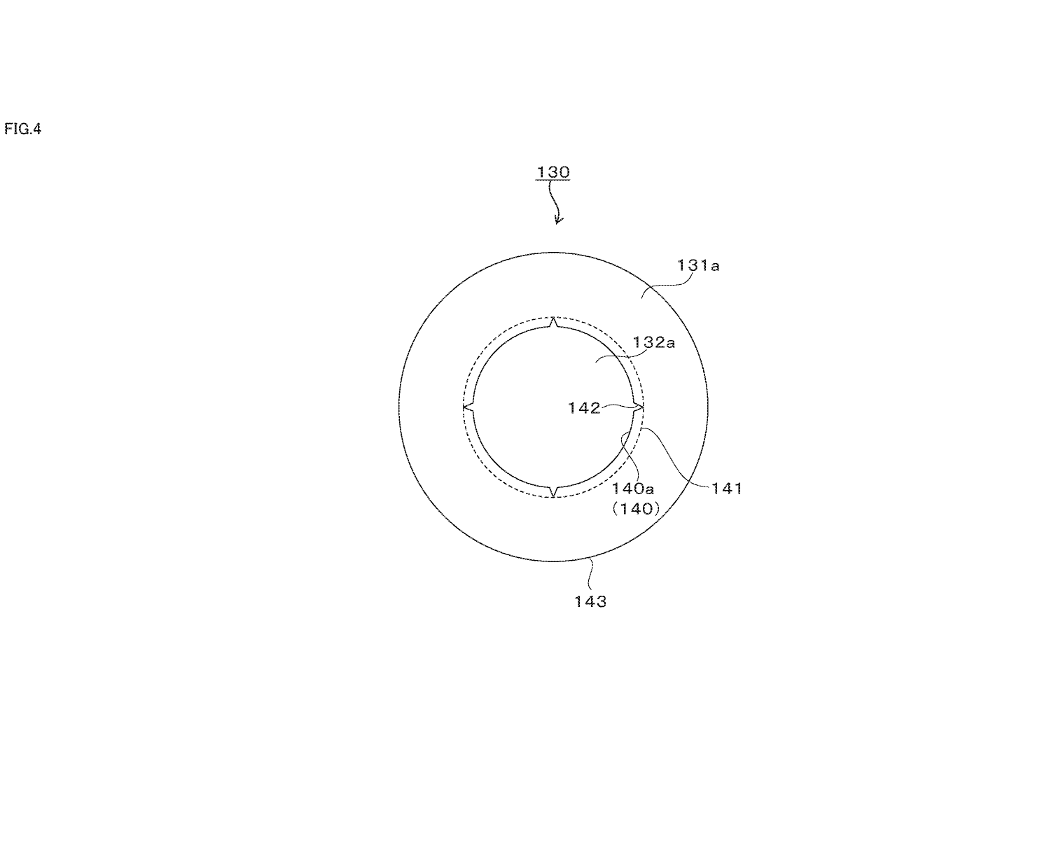

As illustrated in FIG. 3, a sub-chamber 130 according to the second embodiment is provided so as to cover the ventilation vent hole 22 in the main chamber 20 and a peripheral portion thereof from the outer side of the main chamber 20. The sub-chamber 130 is sewn and coupled to the main chamber 20. A sewing portion between the sub-chamber 130 and the main chamber 20 (i.e., a coupling portion 143 between base fabrics of the sub-chamber 130 and the main chamber 20) is formed of one curved line as a whole, and draws a circle as illustrated in FIG. 4 or an ellipse, for example.

As illustrated in FIG. 3, the sub-chamber 130 includes a first base fabric portion 131a coupled to the main chamber 20, and a second base fabric portion 132a that is located farther from the main chamber 20 and is coupled to the first base fabric portion 131a. The first base fabric portion 131a is made of the same low elongation base fabric as in the first embodiment, and the second base fabric portion 132a is made of the same high elongation base fabric as in the first embodiment.

The first base fabric portion 131a is sewn and coupled to the main chamber 20 at the coupling portion 143 set around the ventilation vent hole 22 of the main chamber 20. As illustrated in FIG. 3, an opening 140 opens at a position in the first base fabric portion 131a in a flow direction of the gas from the ventilation vent hole 22. As illustrated in FIG. 3, the second base fabric portion 132a is placed on the opening 140 and a peripheral portion thereof from the inner side of the sub-chamber 130. Since the second base fabric portion 132a is a portion that is desired to be largely inflated when the gas is supplied to the sub-chamber 130, the opening 140 on which the second base fabric portion 132a is placed has a sufficiently large opening area as compared with the ventilation vent hole 22.

As illustrated in FIG. 3, on the outer side of the opening 140 farther from an opening end 140a forming the opening 140 of the first base fabric portion 131a, the first base fabric portion 131a and the second base fabric portion 132a overlap each other. Then, at a sewing position 141 (indicated by arrows in FIG. 3 and indicated by a dotted line in FIG. 4) set on the outer side by a predetermined distance from the opening end 140a, the first base fabric portion 131a and the second base fabric portion 132a are sewn together. As illustrated in FIG. 4, the sewing position 141 makes a round about the opening 140 of the first base fabric portion 131a.

Then, as illustrated in FIG. 4, slits 142 are formed from the opening end 140a toward the sewing position 141 of the first base fabric portion 131a. In FIG. 4, each of the slits 142 is formed by cutting the circumference of the opening 140 of the first base fabric portion 131a in a V-shape. However, the slit 142 is not limited to having the V-shape illustrated in FIG. 4, and may be a straight shape, a rectangular shape, or the like. The number of the slits 142 is four in FIG. 4, but may be 3 or less or five or more. Anyway, preferably, a plurality of slits 142 are formed at equal intervals around the opening 140.

The interior of the sub-chamber 130 formed as above is not divided by base fabrics or the like, and forms one space as a whole.

The actions of the above-described air-bag will be described. When the vehicle receives an impact, the sensor of the air-bag device detects the impact and gas is injected from the inflator. Due to the gas, the main chamber 20 is first inflated, and then the sub-chamber 130 is inflated. The flow of the gas when the sub-chamber 130 is inflated is indicated by arrows in FIG. 3. The second base fabric portion 132a of the sub-chamber 130 is made of the high elongation base fabric, and thus is largely inflated.

Then, although the inflated second base fabric portion 132a of the sub-chamber 130 hits the passenger, the high elongation base fabric forming the second base fabric portion 132a is elongated, and thus a rapid increase in the internal pressure of the air-bag is prevented. In addition, the high elongation base fabric is elongated and hits the passenger like a cushion. Accordingly, the impact to the passenger can be sufficiently reduced.

The effects of the second embodiment will be described. Also in the second embodiment, since the second base fabric portion 132a, which is a part of the sub-chamber 130, is made of the high elongation base fabric, the impact to the passenger can be sufficiently reduced. The sub-chamber 130 includes the first base fabric portion 131a made of the low elongation base fabric and the second base fabric portion 132a made of the high elongation base fabric, and the first base fabric portion 131a made of the low elongation base fabric is coupled to the main chamber 20. Therefore, even when the second base fabric portion 132a made of the high elongation base fabric is largely inflated, the main chamber 20 is less likely to be affected by such inflation.

In addition, the second base fabric portion 132a is sewn to the first base fabric portion 131a at the sewing position 141 set on the outer side of the opening 140 by the predetermined distance from the opening end 140a of the first base fabric portion 131a. Further, the slits 142 are formed in the first base fabric portion 131a from the opening end 140a toward the sewing position 141. Therefore, as compared with a case where no slit 142 is provided, a force loaded from the opening end 140a to the second base fabric portion 132a is reduced, so that tearing or the like is less likely to occur and the second base fabric portion 132a can be largely inflated.

Changes similar to the first embodiment can also be made to the second embodiment.

### 3. Third Embodiment

An air-bag according to the third embodiment also differs from the first embodiment only in the configuration of the sub-chamber.

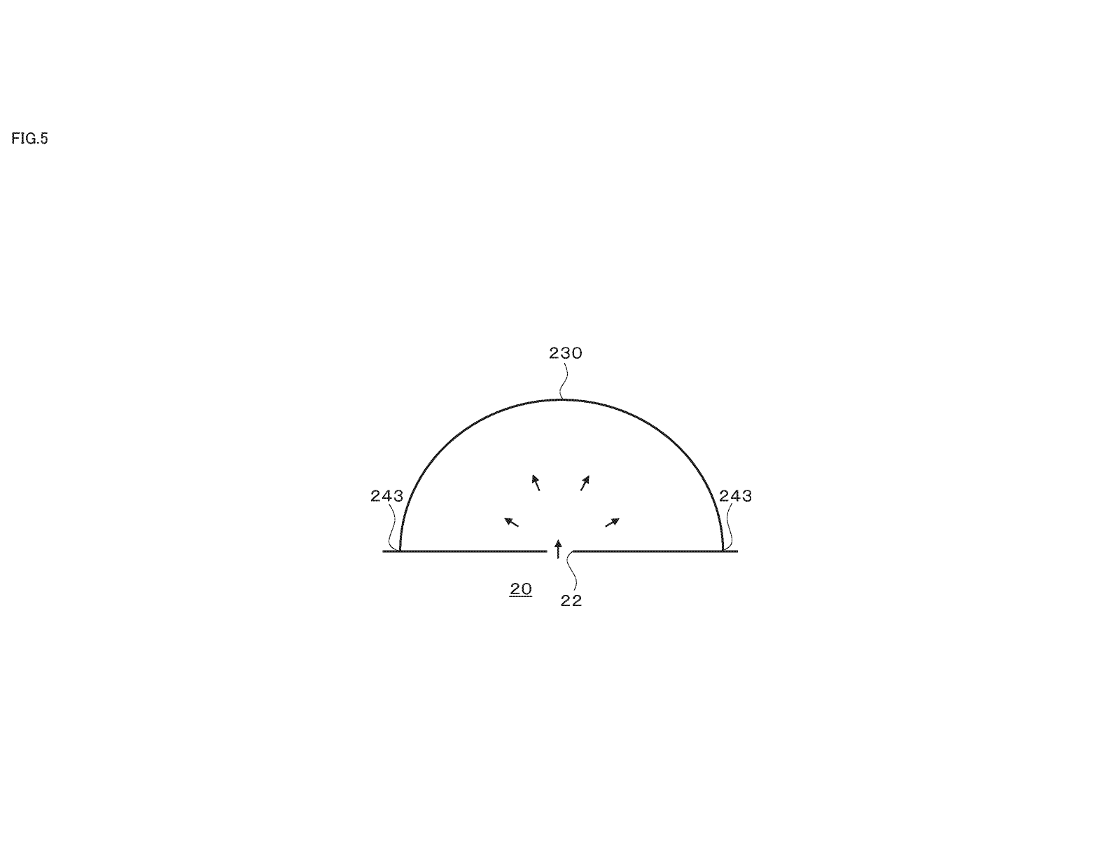

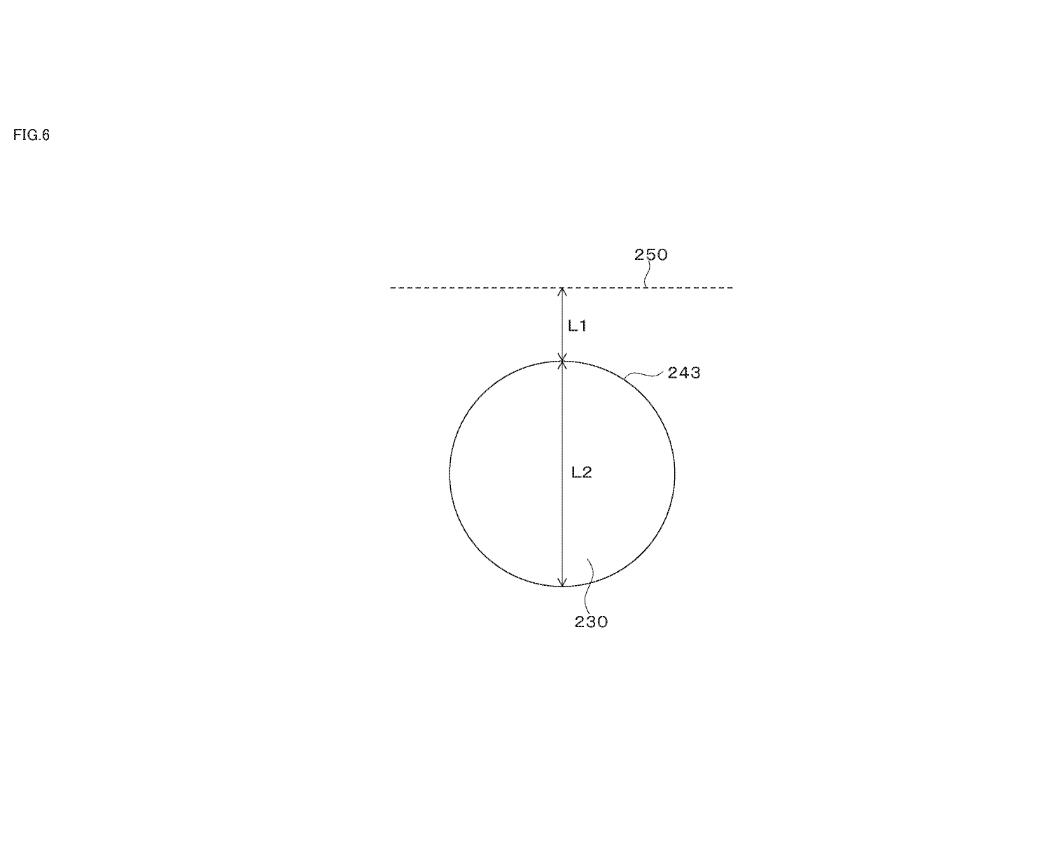

As illustrated in FIG. 5, a sub-chamber 230 according to the third embodiment is provided so as to cover the ventilation vent hole 22 in the main chamber 20 and a peripheral portion thereof from the outer side of the main chamber 20. The sub-chamber 230 is sewn and coupled to the main chamber 20. A sewing portion between the sub-chamber 230 and the main chamber 20 (i.e., a coupling portion 243 between base fabrics of the sub-chamber 230 and the main chamber 20) is formed of one curved line as a whole, and draws a circle as illustrated in FIG. 6 or an ellipse, for example. The entirety of the sub-chamber 230 according to the third embodiment is made of the high elongation base fabric described in the first embodiment.

The main chamber 20 is made by sewing a plurality of low elongation base fabrics. Therefore, as illustrated in FIG. 6, the main chamber 20 is formed with a sewing portion 250 between the low elongation base fabrics.

The sub-chamber 230 is provided away from the sewing portion 250 of the main chamber 20. Specifically, on a straight line orthogonal to an extension line of the sewing portion 250, a distance L1 from the coupling portion 243 of the sub-chamber 230 to the main chamber 20 to the sewing portion 250 of the main chamber 20 is 15% or more of a length L2 of the sub-chamber 230 in a non-elongated state (see FIG. 6).

The actions of the above-described air-bag will be described. When the vehicle receives an impact, the sensor of the air-bag device detects the impact and gas is injected from the inflator. Due to the gas, the main chamber 20 is first inflated, and then the entirety of the sub-chamber 230 is largely inflated. The flow of the gas when the sub-chamber 230 is inflated is indicated by arrows in FIG. 5.

The effects of the third embodiment will be described. Since the entirety of the sub-chamber 230 according to the third embodiment is made of the high elongation base fabric, the entirety of the sub-chamber 230 is largely inflated. Even when the passenger hits any portion of the sub-chamber 230, the impact can be sufficiently reduced.

In addition, since the sub-chamber 230 is located away from the sewing portion 250 of the main chamber 20, even when the sub-chamber 230 is largely inflated, the sewing portion 250 is less likely to be deformed and frays or the like are less likely to occur.

Further, since the sewing part (the coupling portion 243) between the sub-chamber 230 and the main chamber 20 is formed of one curved line as a whole and draws, for example, a circle or an ellipse, a substantially uniform load is applied to the entirety of the coupling portion 243 when the sub-chamber 230 is inflated, and it is possible to prevent a high load from being applied to only a part of the coupling portion 243. Accordingly, the coupling portion 243 is less likely to be torn.

Changes similar to the first embodiment can also be made to the third embodiment.

### REFERENCE SIGNS LIST

10: Air-bag

20: Main chamber

21: Supply port

22: Ventilation vent hole

23: Exhaust vent hole

30: Sub-chamber

31: First chamber

31a: First chamber forming base fabric

32: Second chamber

32a: Second chamber forming base fabric

33: Ventilation hole

43: Coupling portion

130: Sub-chamber

131a: First base fabric portion

132a: Second base fabric portion

140: Opening

140a: Opening end

141: Sewing position

142: Slit

143: Coupling portion

230: Sub-chamber

243: Coupling portion

250: Sewing portion

What is claimed is:

1. An air-bag comprising:
a main chamber configured to be inflated by gas supplied from an inflator; and
a sub-chamber configured to be inflated by being supplied with the gas through a vent hole formed in the main chamber,
the main chamber being made of a low elongation base fabric, and
at least a part of the sub-chamber being made of a high elongation base fabric having larger breaking elongation than the low elongation base fabric.

2. The air-bag according to claim 1, wherein the breaking elongation of the high elongation base fabric is 400% or more.

3. The air-bag according to claim 1, wherein
the main chamber includes, as surfaces during inflation, a front surface located at a position facing the inflator, and side surfaces located on both left and right sides of the front surface, and
the vent hole is provided at least one of the side surfaces.

4. The air-bag according to claim 1, wherein a coupling portion of a base fabric forming the sub-chamber to the main chamber is formed of one curved line as a whole.

5. The air-bag according to claim 1, wherein
the sub-chamber includes
a first chamber forming base fabric coupled to the main chamber so as to cover the vent hole and a peripheral portion of the vent hole, and
a second chamber forming base fabric coupled to the first chamber forming base fabric so as to cover a ventilation hole formed in the first chamber forming base fabric and a peripheral portion of the ventilation hole,
an interior of the sub-chamber is divided into a first chamber surrounded by the main chamber and the first chamber forming base fabric, and a second chamber surrounded by the first chamber forming base fabric and the second chamber forming base fabric, and
the first chamber forming base fabric is made of the low elongation base fabric and the second chamber forming base fabric is made of the high elongation base fabric.

6. The air-bag according to claim 1, wherein
the sub-chamber includes
a first base fabric portion coupled to the main chamber and having an opening, and
a second base fabric portion placed on a portion including the opening in the first base fabric portion from an inner side of the sub-chamber,
the first base fabric portion is made of the low elongation base fabric and the second base fabric portion is made of the high elongation base fabric,
the second base fabric portion is sewn to the first base fabric portion so as to surround the opening at a sewing position set on an outer side of the opening by a predetermined distance from an opening end of the opening, and
a slit is formed in the first base fabric portion from the opening end toward the sewing position.

7. The air-bag according to claim 1, wherein
the main chamber is formed with a sewing portion between the low elongation base fabric and the low elongation base fabric
an entirety of the sub-chamber is made of the high elongation base fabric, and
on a straight line orthogonal to an extension line of the sewing portion, a distance from a coupling portion of the sub-chamber to the main chamber to the sewing portion is 15% or more of a length of the sub-chamber in a non-elongated state.

8. The air-bag according to claim 1, wherein an entirety of the main chamber is made of the low elongation base fabric.
